(19) United States
(12) Patent Application Publication
(10) Pub. No.: US 2026/0244970 A1
(43) Pub. Date: Aug. 20, 2026

(54) SYSTEM AND METHOD OF CARRIER-FREE RAMAN TRANSITION FOR ENTANGLEMENT GENERATION WITH TRAPPED IONS

(71) Applicant: Duke University, Durham, NC (US)

(72) Inventors: Jacob Whitlow, Durham, NC (US); Jungsang Kim, Durham, NC (US)

(21) Appl. No.: 19/544,335

(22) Filed: Feb. 19, 2026

Related U.S. Application Data
(60) Provisional application No. 63/760,362, filed on Feb. 19, 2025.

(51) Int. Cl. G06N 10/40; G21K 1/20

(52) U.S. Cl. CPC G06N 10/40; G21K 1/20

(57) ABSTRACT

Technologies for generating entanglement in a quantum computing system include confining ions in trapping potentials that define at least one shared motional mode. First and second electromagnetic fields are generated and combined to form a Raman interaction field having a frequency difference corresponding to an internal state transition of the ions. At least one of the electromagnetic fields is spatially structured to produce an electric-field null and a transverse spatial gradient. The Raman interaction field is directed toward the ions such that at least one ion is positioned at the electric-field null. Application of the Raman interaction field induces coupling between internal states of the ions and the shared motional mode while suppressing carrier transitions by the spatial field structure. Coupling of internal states of multiple ions to the shared motional mode mediates entanglement between the ions.

### CROSS-REFERENCE TO RELATED APPLICATIONS

This patent application claims priority to U.S. Provisional Patent Application Ser. No. 63/760,362, filed Feb. 19, 2025, which is incorporated by reference in entirety herein.

### GOVERNMENT LICENSE RIGHTS

This invention was made with government support under Federal Grant No. PHY-2325080 awarded by the National Science Foundation. The government has certain rights in the invention.

### FIELD

The present disclosure generally relates to quantum computing, and more specifically to systems and methods for generating entanglement between trapped ions using optically mediated interactions.

### BACKGROUND

Trapped ion quantum computing systems use the internal states of ions to represent qubit states. Interactions between ions may be generated by coupling internal states to one or more shared motional modes of ions confined in a trapping potential. One common approach for generating such coupling uses Raman transitions driven by two optical fields having a frequency difference corresponding to an energy separation between internal states of the ion. In entangling operations, the optical fields are typically arranged in a counter-propagating geometry such that momentum transfer from the optical fields couples the internal states of the ions to collective motional modes. The shared motional modes can then mediate effective spin-spin interactions between ions, enabling multi-qubit entangling gates.

However, counter-propagating Raman transition approaches introduce technical challenges that potentially complicate system design and limit scalability. For example, counter-propagating optical fields generally require multiple optical paths to be precisely aligned and phase-stabilized. Small fluctuations in optical path length, timing, or alignment can result in phase noise, decoherence, or gate errors. Further, Raman-based entangling gates often suffer from off-resonant excitation of carrier transitions that do not couple to motional modes. Such carrier interactions can introduce error, reduce gate fidelity, and require additional compensation techniques. Increasing optical power to accelerate gate operations may further increase undesired carrier coupling or spontaneous emission errors.

### SUMMARY

An embodiment presented herein discloses a method. The method generally includes generating, by a quantum computing system confining quantum particles in respective trapping potentials defining at least one shared bosonic mode, a first electromagnetic field having a first spatial field profile. The method also generally includes generating a second electromagnetic field having a second spatial field profile, the second spatial field profile comprising an electric-field null region and a non-zero transverse spatial gradient in a vicinity of the null region. The first electromagnetic field and the second electromagnetic field are combined to form a driven interaction field having a frequency component corresponding to an internal state transition of the quantum particles. The driven interaction field is directed toward the plurality of quantum particles such that at least one quantum particle is positioned substantially at the null region of the second spatial field. The driven interaction field is applied to induce a transition that couples an internal state of the at least one quantum particle to the shared bosonic mode while structurally suppressing a carrier transition of the internal state, thereby mediating entanglement between the quantum particles.

Another embodiment presented herein discloses a quantum computing system having a quantum processing unit, one or more processors, and a memory storing instructions. The instructions, when executed on the processors, causes the quantum computing system to confine quantum particles in respective trapping potentials defining at least one shared bosonic mode. A first electromagnetic field having a first spatial field profile is generated. A second electromagnetic field having a second spatial field profile is generated. The second spatial field profile comprising an electric-field null region and a non-zero transverse spatial gradient in a vicinity of the null region. The quantum computing system combines the first electromagnetic field and the second electromagnetic field to form a driven interaction field having a frequency component corresponding to an internal state transition of the quantum particles. The driven interaction field is directed toward the plurality of quantum particles such that at least one quantum particle is positioned substantially at the null region of the second spatial field. The driven interaction field is applied to induce a transition that couples an internal state of the at least one quantum particle to the shared bosonic mode while structurally suppressing a carrier transition of the internal state, thereby mediating entanglement between the quantum particles.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a partial view of an ion trap quantum computer, according to an embodiment;

FIG. 2 is a schematic view of an ion trap for confining ions in a chain, according to an embodiment;

FIG. 3 is a conceptual diagram of a beam path of an example co-propagating Raman optical architecture of the ion trap quantum computer of FIG. 1, according to an embodiment;

FIG. 4 is a conceptual diagram of a beam path of another example of a co-propagating Raman optical architecture of the ion trap quantum computer of FIG. 1, according to an embodiment;

FIG. 5 is a flow diagram of an example method for performing entanglement in the ion trap quantum computer of FIG. 1 using optically mediated interactions, according to an embodiment;

FIGS. 6A and 6B are graph diagrams depicting combined profiles of lasers interacting with ions of the ion trap quantum computer of FIG. 1 to perform a Ramen carrier transition, according to an embodiment;

FIG. 7A is a graph diagram depicting the full spectrum surrounding the carrier transition when the ion is placed at the center of the profile of FIG. 6A, according to an embodiment;

FIG. 7B is a graph diagram depicting a carrier transition resulting from driving the carrier and blue sideband transition when the ion is ground state-cooled using sideband cooling on the red sideband, according to an embodiment; and

FIG. 8 is a graph diagram demonstrating feasibility of using Hermite-Gaussian profile Raman transitions to perform spin-spin entanglement, according to an embodiment.

### DETAILED DESCRIPTION

Embodiments presented herein disclose technologies for generating entanglement in quantum computing systems, such as trapped-ion quantum computing systems, using optically mediated interactions that suppress undesired carrier transitions while preserving controllable coupling between internal states of ions and motional modes of an ion trap.

The disclosed technology may implement a Raman interaction using optical fields that are configured to co-propagate toward one or more trapped ions. As further described herein, at least one of the optical fields has a spatially structured intensity profile that includes an electric-field null region and a transverse spatial gradient in a region occupied by an ion. When the ion is positioned substantially at the null region, direct carrier transitions between internal states of the ion are suppressed while transitions that couple the internal states of the ion to one or more motional modes remain enabled due to the transverse gradient of the optical field.

In contrast to approaches that rely on counter-propagating optical fields to generate motional coupling through longitudinal momentum transfer, the disclosed technology generates spin-motion coupling using a transverse spatial gradient of a co-propagating optical field. As a result, the disclosed technology reduces sensitivity to optical path length differences, alignment tolerances, and timing constraints associated with multiple optical paths, while still enabling entangling interactions mediated by shared motional modes of the ion trap.

In some embodiments, the disclosed technology generates the spatially structured optical field using a mode-conversion element that transforms an optical field having a substantially Gaussian spatial profile into a higher-order spatial profile having a null and a transverse gradient. In an embodiment, the spatially structured profile corresponds to a first-order Hermite-Gaussian mode. However, the disclosed technology is not limited to Hermite-Gaussian modes, and other spatial profiles capable of producing an electric-field null with an associated gradient may be used.

The disclosed technology may be used to generate spin-motion entanglement for a single ion, as well as spin-spin entanglement between multiple ions via one or more shared motional modes. In addition, by repositioning an ion relative to the spatially structured optical field, or by steering the optical field relative to the ion, the same optical system may be selectively configured to enable or suppress carrier transitions, thereby supporting both multi-qubit entangling operations and single-qubit operations within a common optical architecture.

Advantageously, the disclosed approach suppresses carrier transitions structurally by positioning an ion at an electric-field null of a spatially structured optical field. Carrier suppression is achieved without requiring fine frequency tuning, pulse shaping, or active cancellation of carrier terms, thereby reducing non-commuting errors associated with off-resonant carrier excitation. Further advantageously, by generating a transverse spatial gradient in a co-propagating optical field, the disclosed techniques preserve coupling between internal states of ions and motional modes while avoiding reliance on counter-propagating optical fields. This enables entangling interactions mediated by shared motional modes without requiring longitudinal momentum transfer between optical fields. Further still, because the Raman interaction fields may be co-propagating, the disclosed systems reduce sensitivity to differential optical path length fluctuations, phase noise, and alignment drift that can arise when multiple optical paths must intersect at an ion location. This simplifies optical alignment and improves robustness against environmental perturbations.

In addition, the disclosed technology supports dynamic switching between different operational modes. For example, by repositioning an ion relative to the spatially structured optical field, or by steering the optical field, the system may be configured to suppress carrier transitions for entangling operations or to enable carrier transitions for single-qubit operations. This reconfigurability allows a single optical architecture to support a full set of quantum gate operations.

The co-propagating optical architecture described herein is compatible with beam-steering elements such as acousto-optic deflectors and may be extended to address multiple ions along an ion chain or across multiple trapping zones. As a result, the disclosed technology supports scalable trapped-ion architectures without introducing additional optical paths for entangling operations. By combining multiple spatially structured optical fields or spatial modes, the disclosed techniques may be extended to generate higher-order or nonlinear couplings between internal states and motional modes. Such capabilities are advantageous for advanced entangling gates and quantum simulation applications that require controlled access to higher-order motional interactions.

Note, the following description uses an ion trap quantum computing system as a reference example of a quantum computing system capable of using a spatially structured driving field with a field null and transverse gradient to suppress carrier transitions while preserving controlling coupling to a secondary mode. However, one of skill in the art will recognize that the embodiments of the disclosed technology may be adapted to a variety of quantum computing systems, such as quantum computing systems that rely on bosonic modes for mediated interactions.

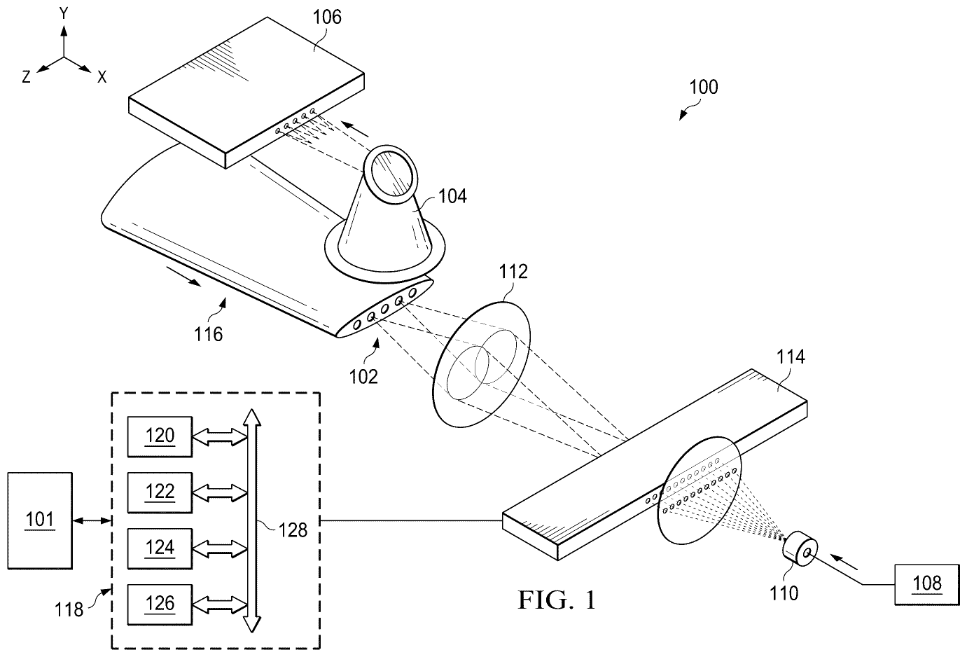

FIG. 1 is a partial view of an example ion trap quantum computer, or system 100, configured to perform entanglement operations based on Raman interactions using optical fields that are configured to co-propagate towards one or more trapped ions. The system 100 includes a classical (digital) computer 101, a system controller 118 and a quantum processing unit (QPU) incorporating a quantum register that is a chain 102 of trapped ions (i.e., five shown) in a linear crystal and extending along the Z-axis. The classical computer 101 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms, and data can be coded and stored within the memory for instructing the CPU. The support circuits (not shown) are also connected to the CPU for supporting the processor in a conventional manner. The support circuits may include conventional cache, power supplies, clock circuits, input/output circuitry, subsystems, and the like.

Note, although the system 100 shows one quantum register having the chain 102 of trapped ions, the system may include multiple quantum registers each having a chain 102. The quantum registers may be arranged physically (e.g., using separate ion traps), logically (e.g., using logically distinct groupings within one or more physical registers), or some combination of both.

An imaging objective 104, such as an objective lens with a numerical aperture (NA), for example, of 0.37, collects fluorescence along the Y-axis from the ions and maps each ion onto a multi-channel photo-multiplier tube (PMT) 106 for measurement of individual ions. Non-copropagating Raman laser beams from a laser 108, which are provided along the X-axis, perform operations on the ions. A diffractive beam splitter 110 creates an array of static Raman beams 112 that are individually switched using a multi-channel acousto-optic modulator (AOM) 114 and is configured to selectively act on individual ions. A global Raman laser beam 116 illuminates all ions at once.

The system controller (also referred to as a “RF controller”) 118 controls the AOM 114. The system controller 118 includes a central processing unit (CPU) 120, a read-only memory (ROM) 122, a random access memory (RAM) 124, a storage unit 126, and the like. The CPU 120 is a processor of the RF controller 118. The ROM 122 stores various programs and the RAM 124 is the working memory for various programs and data. The storage unit 126 includes a nonvolatile memory, such as a hard disk drive (HDD) or a flash memory, and stores various programs even if power is turned off. The CPU 120, the ROM 122, the RAM 124, and the storage unit 126 are interconnected via a bus 128.

The RF controller 118 executes a control program which is stored in the ROM 122 or the storage unit 126 and uses the RAM 124 as a working area. The control program will include software applications that include program code that may be executed by processor in order to perform various functionalities associated with receiving and analyzing data and controlling any and all aspects of the methods and hardware used to create the ion trap quantum computer system 100 discussed herein. For example, the control program may include program code for generating a first electromagnetic field having a first spatial field profile and a second electromagnetic field having a second spatial field profile, combining the electromagnetic fields to form a driven interaction field, directing the driven interaction field toward ions such that at last one ion is positioned substantially at a null region of the second spatial field, and applying the driven interaction field to induce a transition that couples an internal state of the ion to a shared bosonic mode and mediate entanglement between ions.

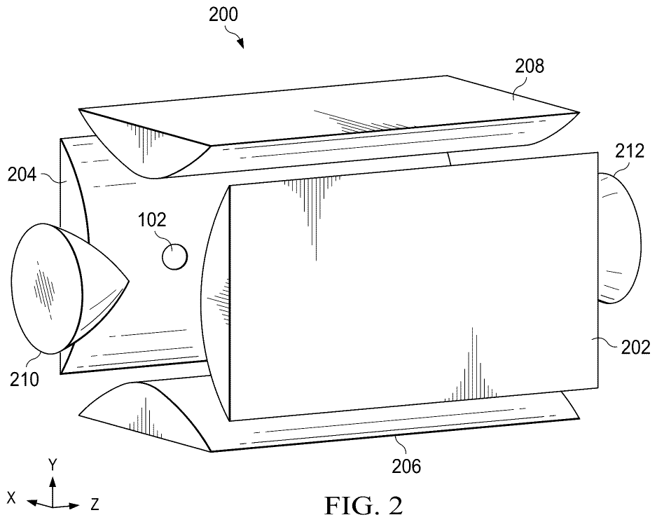

FIG. 2 depicts a schematic view of an ion trap 200 (also referred to as a Paul trap) for confining ions in a given chain 102 in a linear crystal, according to an embodiment. The confining potential is exerted by both static (DC) voltage and radio frequency (RF) voltages. A static (DC) voltage vs is applied to end-cap electrodes 210 and 212 to confine the ions along the Z-axis (also referred to as an “axial direction” or a “longitudinal direction”). The ions in the chain 102 are nearly evenly distributed in the axial direction due to the Coulomb interaction between the ions. In some embodiments, the ion trap 200 includes four hyperbolically-shaped electrodes 202, 204, 206, and 208 extending along the Z-axis.

During operation, a sinusoidal voltage V₁ (with an amplitude V_{RF}/2) is applied to an opposing pair of the electrodes 202, 204 and a sinusoidal voltage V₂ with a phase shift of 180° from the sinusoidal voltage V₁ (and the amplitude V_{RF}/2) is applied to the other opposing pair of the electrodes 206, 208 at a driving frequency ω̅_{RF}, generating a quadrupole potential. In some embodiments, a sinusoidal voltage is only applied to one opposing pair of the electrodes 202, 204, and the other opposing pair 206, 208 is grounded.

The quadrupole potential creates an effective confining force in the X-Y plane perpendicular to the Z-axis (also referred to as a “radial direction” or “transverse direction”) for each of the trapped ions, which is proportional to a distance from a saddle point (i.e., a position in the axial direction (Z-direction)) at which the RF electric field vanishes. The motion in the radial direction (i.e., direction in the X-Y plane) of each ion is approximated as a harmonic oscillation (referred to as secular motion) with a restoring force towards the saddle point in the radial direction and can be modeled by spring constants kₓ and k_{y}, respectively, as is discussed in greater detail below. In some embodiments, the spring constants in the radial direction are modeled as equal when the quadrupole potential is symmetric in the radial direction.

In an embodiment, each ion in the chain 102 may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.642821 GHz. A qubit is formed with the two hyperfine states, denoted as |0 [symbol] and |1 [symbol] where the hyperfine ground state (i.e., the lower energy state of the ²S_{1/2} hyperfine states) is chosen to represent |0 [symbol] . Hereinafter, the terms “hyperfine states,” “internal hyperfine states,” and “qubits” may be interchangeably used to represent |0 [symbol] and |1 [symbol] . Each ion may be cooled i.e. kinetic energy of the ion may be reduced) to near the motional ground state |0 [symbol] ₚ for any motional mode p with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₚ with the subscript p denotes the motional ground state for a motional mode p of a chain 102 of trapped ions.

An individual qubit state of each trapped ion may be manipulated by, for example, a mode-locked laser at 355 nanometers (nm) via the excited ²P_{1/2} level (denoted as |e [symbol] . A laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ, with respect to the transition frequency ω₀ₑ between |0 [symbol] and |e [symbol] . A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency A is much larger than a two-photon transition detuning frequency (also referred to simply as “detuning frequency”) δ=ω₁−ω₂−ω₀₁ (hereinafter denoted as +μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀, and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₁ cool may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be+, Ca+, Sr+, Mg+, and Ba+) or transition metal ions (Zn+, Hg+, Cd+).

Given an ion with a hyperfine transition in the ²S_{1/2} manifold split by ω>_{hf} trapped in a three-dimensional harmonic potential, the base Hamiltonian is defined by

$${H}_{0} = \frac{{ω}_{hf}}{2} {σ}_{z} + vn$$

where σ_{z} is the Pauli operator and n is the number operator. Assume a laser shined on the ion that drives a Raman transition via virtual excitation to the P-manifold includes two co-propagating frequencies to make up the hyperfine frequency difference. The interaction Hamiltonian can be expressed as

$${H}_{i} = \frac{Ω ( x )}{2} ( σ + {e}^{- i Δ t} + σ - {e}^{i Δ t} ) ,$$

where Δ is the beat note of the two tones that form the Raman transition and Ω is a two photon Rabi frequency defined by

$$Ω ( x ) = \frac{{E}_{0} ( x ) {E}_{1} ( x )}{4 {ℏ}^{2}} {\sum }_{i} \frac{〈 0 \vert {\vec{ϵ}}_{0} \cdot \vec{d} \vert i 〉 〈 i \vert {\vec{ϵ}}_{1} \cdot \vec{d} \vert 1 〉}{{Δ}_{i}} ,$$

where Δᵢ is the detuning from each virtual state in the Raman process, E₀ and E₁ are the electric field strengths, \vec{ϵ}₀ and \vec{ϵ}₁ are the polarizations, and [symbol] is the dipole operator. In this example, assume that E₀(x) is a perfect Gaussian beam with the center aligned directly to the ion and waist ω₀ large relative to the spread of the ion, such that E₀(x)=E₀ exp(−x²/ω₀) ≈E₀ is roughly a constant. Further assume that E₁(x) is a TEM01 Hermite-Gaussian mode defined by

$${E}_{1} ( x ) = {E}_{1} 2 \sqrt{2} \frac{x}{{w}_{1}} exp ( - {x}^{2} / {w}_{1}^{2} ) .$$

Further assume, to ignore higher than first order spatial dependence, that

$$2 \sqrt{2} \frac{x}{{w}_{1}} ≪ 1 ,$$

which may result in motional coupling being small but the dominant term due to lack of carrier coupling. As a result,

$${E}_{1} ( x ) \approx {E}_{1} 2 \sqrt{2} \frac{x}{{w}_{1}} .$$

Doing so is equivalent to making the Lamb-Dicke approximation in counter-propagating gates but with a modified parameter. η and Ω₀ may be quantized and set such that

$$η = 2 \sqrt{2} \frac{{x}_{0}}{{w}_{1}} and {Ω}_{0} = \frac{{E}_{0} {E}_{1}}{4 {ℏ}^{2}} {\sum }_{i} \frac{〈 0 \vert {\vec{ϵ}}_{0} \cdot \vec{d} \vert i 〉 〈 i \vert {\vec{ϵ}}_{1} \cdot \vec{d} \vert 1 〉}{{Δ}_{i}} ,$$

where x₀ is the vacuum spread of the ion's motion. Doing so results in the following interaction Hamiltonian:

$${H}_{i} = \frac{{ηΩ}_{0}}{2} ( a + {a}^{†} ) ( {σ}_{+} {e}^{- i Δ t} + {σ}_{-} {e}^{i Δ t} ) .$$

Rotating away H₀ results in the following Hamiltonian

$${H}_{I} = \frac{{ηΩ}_{0}}{2} ( {ae}^{- ivt} + {a}^{†} {e}^{ivt} ) ( {σ}_{+} {e}^{- i δ t} + {σ}_{-} {e}^{i δ t} ) ,$$

which is the spin-motion interaction Hamiltonian that comes from the light matter interaction of an atom in a harmonic potential, differing in that there is no carrier interaction (only sidebands), and there is no phase difference that comes from the first-order expansion of a complex exponential. The accuracy of such approximation may be quantified with Lamb-Dicke requirement: η² (n̅+1)«1, in which η is inversely proportional to the waist.

By applying two Raman interactions of the above type onto an ion at the same time, in which one interaction is close to resonance with red sideband (δ=−v) and the other interaction is close to resonance with the blue sideband (δ=v), the system 100 can tune the effective harmonic potential and spin-dependent force. By adding a second ion and applying the same interaction Hamiltonian, the system 100 may perform a Mølmer-Sorensen gate using only the gradient of the beam profile. Doing so has several distinct advantages over the typical counter-propagating Raman transition. For instance, coupling to the motion is completely controllable based on how focused the beam is. This is quantified by the effective Lamb-Dicke parameter of the interaction. By focusing the beam to a waist that is about the same as the laser wavelength, a similar Lamb-Dicke parameter as that of a counter-propagating Raman transition can be achieved. However, being constrained to allow the waist to be larger, the system 100 may be configured to make the Lamb-Dicke parameter smaller, which inherently results in the interactions being less sensitive to heating (at the price of a slower gate). However, another advantage is the presence of a null-point at the center of the beam, i.e., the carrier transition is completely suppressed. As a result, the system 100 may compensate for lower coupling with more laser power without needing to factor off-resonant coupling to the carrier. Further still, even if the ion is not at the exact center of the beam, the coupling to the carrier transition does not have the typical phase offset associated with counter-propagating gates, thus allowing for the system 100 to dynamically decouple the effect. In addition, such interaction allows the system 100 ease of switching between pure co-propagating gates (which do not couple to motion) and co-propagating gates with a gradient while still maintaining phase coherence. For example, when performing entangling gates, the ions may be arranged at the null point of the Raman transition. When performing single qubit gates, the system 100 may shuttle an ion (e.g., move the beam) such that the ion is at the maximum of the of the laser intensity. The profile of the Rabi frequency ωt this point is

$$Ω ( x \pm \frac{{w}_{1}}{\sqrt{2}} ) = 2 {Ω}_{0} ( 1 \pm \sqrt{2} \frac{x}{{w}_{1}} ) exp ( - {( {w}_{1} / \sqrt{2} \pm x )}^{2} / {w}_{1} ,$$

which has no first derivative and will not couple into the first-order sidebands. In addition, high-order coupling is minimal due to large waist, which can result in a pure carrier transition.

In some embodiments, the system 100 may use Hermite-Gaussian profiles for spin-motion simulations and operations. For example, for any simulation relying on the presence of first-order terms and an absence of the carrier, such profile is used for spin-spin entanglement as discussed above.

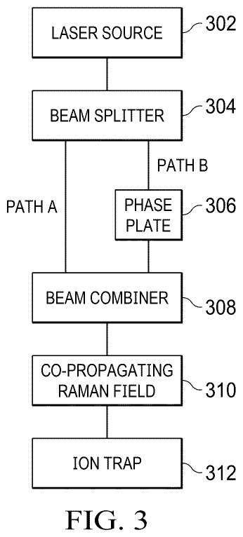

Referring now to FIG. 3, a conceptual diagram of an example optical architecture for generating a driven interaction field used to induce carrier-suppressed Raman transitions in the system 100. The system 100 may include a laser source 302 (e.g., laser 108 of the system 100), which may be configured to emit coherent electromagnetic radiation at an optical wavelength suitable for driving Raman transitions between internal states of trapped ions. In some embodiments, the laser source 302 represents a single laser source. Of course, multiple laser sources may also be contemplated.

Illustratively, the laser source 302 is provided to a beam splitter 304 (e.g., beam splitter 110) configured to divide the laser into multiple optical paths (e.g., a Path A and Path B as shown). Optical Path A generates a first electromagnetic field using a first spatial field profile. In some embodiments, the first spatial field profile is a substantially Gaussian spatial profile, although other profiles may be used.

Optical Path B generates a second electromagnetic field having a second spatial field profile that differs from the first spatial field profile. In particular, the second spatial field profile includes an electric-field null region and a non-zero transverse spatial gradient in a vicinity of the null region (e.g., a region in which the electric field amplitude is sufficiently small to suppress carrier transitions and the gradient of the field is non-zero), such as a Hermite-Gaussian spatial profile. To generate the second spatial field profile, the Path B includes a mode-conversion element, such as a mode-conversion phase plate 306. In other embodiments, the mode-conversion element may comprise a spatial light modulator, a diffractive optical element, or another optical component capable of modifying the spatial phase and/or amplitude of the electromagnetic field. In certain embodiments, the phase plate 306 is configured to convert an incident Gaussian field into a Hermite-Gaussian or Laguerre-Gaussian spatial mode.

Optical Paths A and B may further include frequency-shifting elements (not shown), such as acousto-optic modulators or electro-optic modulators, configured to impart a controlled frequency offset to one or both electromagnetic fields. The frequency difference between the electromagnetic fields is selected to correspond to an internal state transition of the trapped ions, thereby enabling a Raman interaction.

After spatial and frequency conditioning, the electromagnetic fields from Paths A and B are combined by an optical combining element. The optical combining element may comprise a beam combiner (e.g., beam combiner 308), polarization-based combiner, or other suitable optical component. The beam combiner 308 is configured to produce a driven interaction field (e.g., co-propagating Raman field 310) in which the first and second electromagnetic fields co-propagate along a common propagation direction. The co-propagating Raman field 310 is directed toward an ion trap 312 (e.g., the ion trap 200) that confines ions in respective trapping potentials defining one or more shared motional modes.

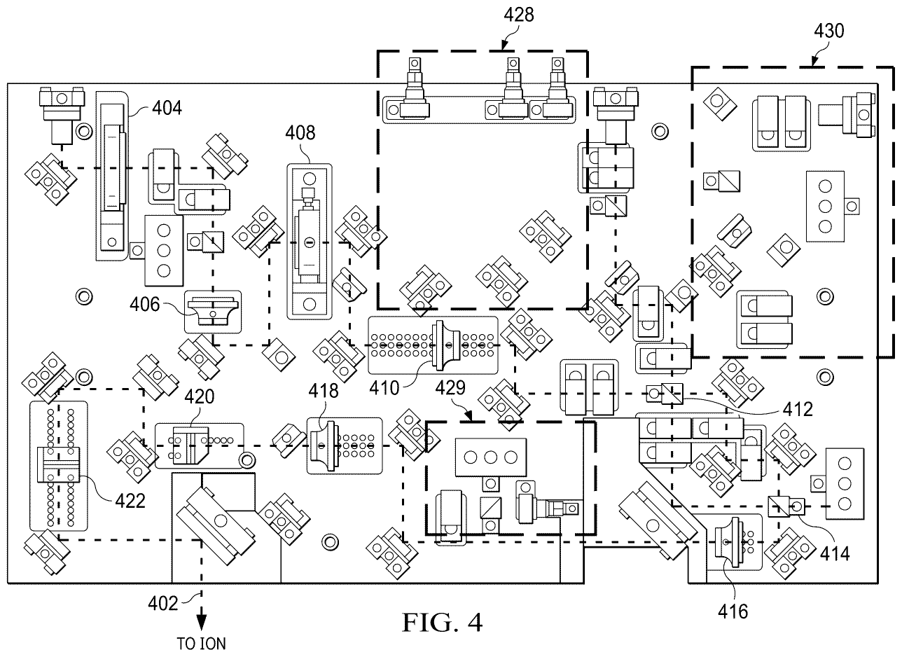

FIG. 4 illustrates a schematic layout of an example optical configuration of the system 100 and of another example of a beam optical path, in which the dotted line 402 depicts the path of the laser. A Hermite-Gaussian beam goes through phase plate 404 followed by spatial filters 406, 408, 410 to clean the beam profile and remove any extended tails. The Hermite-Gaussian beam is combined with a pure Gaussian beam at beam splitters 412, 414. Telescopes 416, 418 may be used to adjust beam size and mode quality at the ion location, such as to provide beam waist control and preserve mode quality. The beam is focused down to the ion within the chamber using de-magnifying lens 420, 422. The rest of the plate includes beam samplers to measure intensity (e.g., via intensity locking components 428), perform phase stabilization and frequency control (e.g., optical beat note 429), and provide an extra beam path 430 that could allow for another Gaussian beam to enter for the purpose of individual ion state preparation.

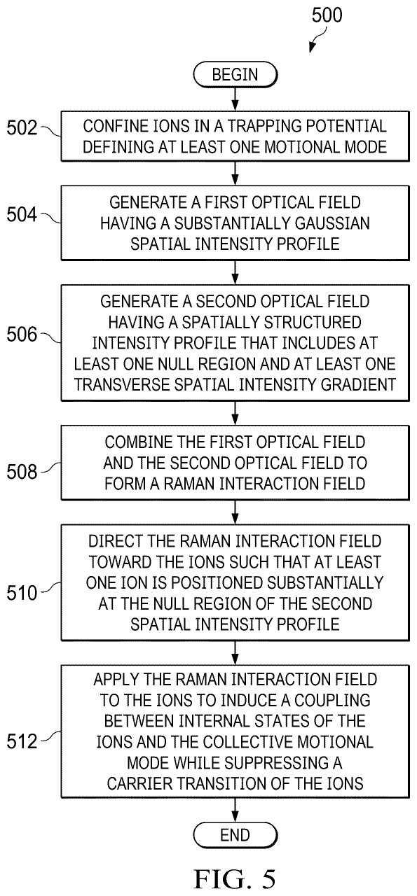

Referring now to FIG. 5, the quantum computing system 100, in operation, may perform a method 500 for generating entanglement based on Raman interactions using optical fields that are configured to co-propagate towards one or more trapped ions.

As shown, the method 500 begins in block 502, in which the system 100 confines ions in a trapping potential (e.g., the ion trap 200) defining at least one motional mode. In this example, assume that the ion trap 200 includes ¹⁷¹Yb⁺ ions cooled to about 8K. Further assume that the system 100 initializes the ions by pulsing a 532 nm laser at an ablation source of neutral Ytterbium. The system 100 may perform two-step ionization with 399 nm light that is resonant with the neutral S−P transition followed by 355 nm that excites the electron to the continuum. The system 100 may perform doppler cooling with 369.5 nm light resonant with the ion's S−P transition.

In block 504, the system 100 generates a first optical field having a substantially Gaussian spatial intensity profile. In block 506, the system 100 generates a second optical field having a spatially structured intensity profile that includes at last one null region and at least one transverse spatial intensity gradient, such as a Hermite-Gaussian spatial intensity profile. In practice, the pulse width applied may be approximately about 15 μs with a rep rate of 119 MHz, resulting in frequency combs within a bandwidth encompassing a 12.642 GHz transition for ¹⁷¹Yb⁺. Applying two RF frequencies via a direct digital synthesis (DDS) and acousto-optic modulator (AOM) to the laser allows the system 100 to tune frequency combs to be resonant with the transition. While such tones may be on the same beam or on separate beams, in some embodiments, the system 100 applies the tones to separate beams, one of which being of the Hermite-Gaussian profile.

In block 508, the system 100 combines the first optical field and the second optical field to form a Raman interaction field, e.g., using a beam splitter. To create the first-order beam, the phase plate of the system 100 changes the phase of one half of the beam by R with respect to the other half Doing so results in a beam that resembles a first order Hermite-Gaussian mode but with a longer tail on the sides. Apertures such as pinholes in the system 100 may shape the beam and remove the tail.

In block 510, the system 100 directs the Raman interaction field towards the ions such that at least one of ion is positioned substantially at the null region of the second spatial intensity profile. To do so, the system 100 may focus the beam to about a given value in waist (e.g., 1.4 μm) in the axial direction of the ion chain at the position of the target ion (which is also the direction of the Hermite-Gaussian profile). In an embodiment, the system 100 may focus the radial direction of the beam to 10 μm to avoid clipping with the trap 200. The axial center of mass trapping frequency is typically 2π×870 kHz, which allows a measure of spacing (e.g., 3.78 μm) for a pair of ¹⁷¹Yb⁺ ions. Such spacing provides for an effective Lamb-Dicke parameter of η≈0.011 for one ion, which is an order of magnitude lower than prior approaches that involved counter-propagating Raman transitions. In block 512, the system 100 applies the Raman interaction field to the ions to induce a coupling between internal states of the ions and the collective motional mode while suppressing a carrier transition of the ions. In an embodiment, to address both ions simultaneously (e.g., in two-qubit operations), the system 100 may use both outputs of the beam splitter that combines the zeroth and first-order beams. The system 100 may then combine the outputs at another beam splitter such to allow the outputs to co-propagate throughout the beam path until focused to the ion plane. Once both are aligned to a single ion, the system 100 may adjust the beam path of one set of tones such that the tones hit the second ion. The beams may be aligned such that the ions are at the center of the Hermite-Gaussian mode.

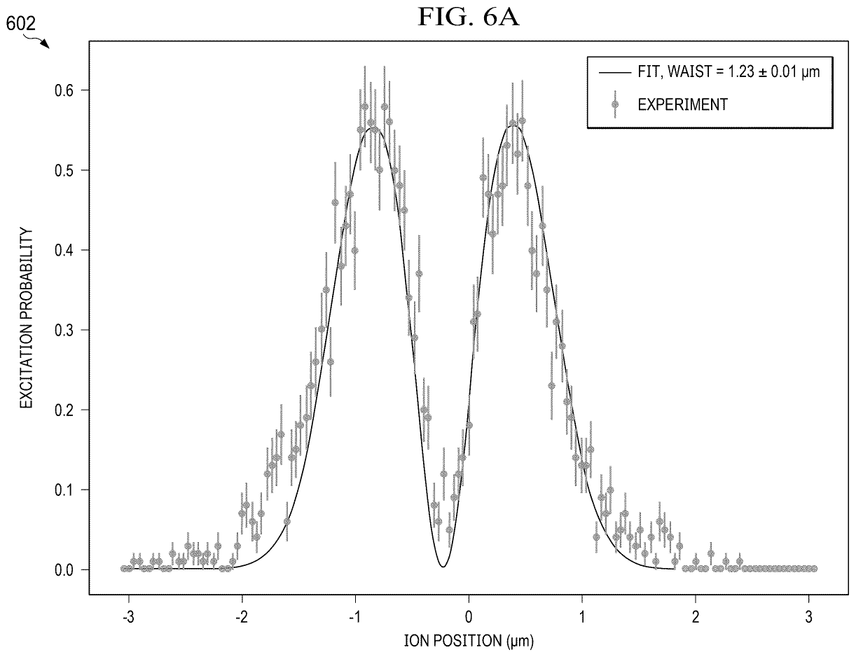

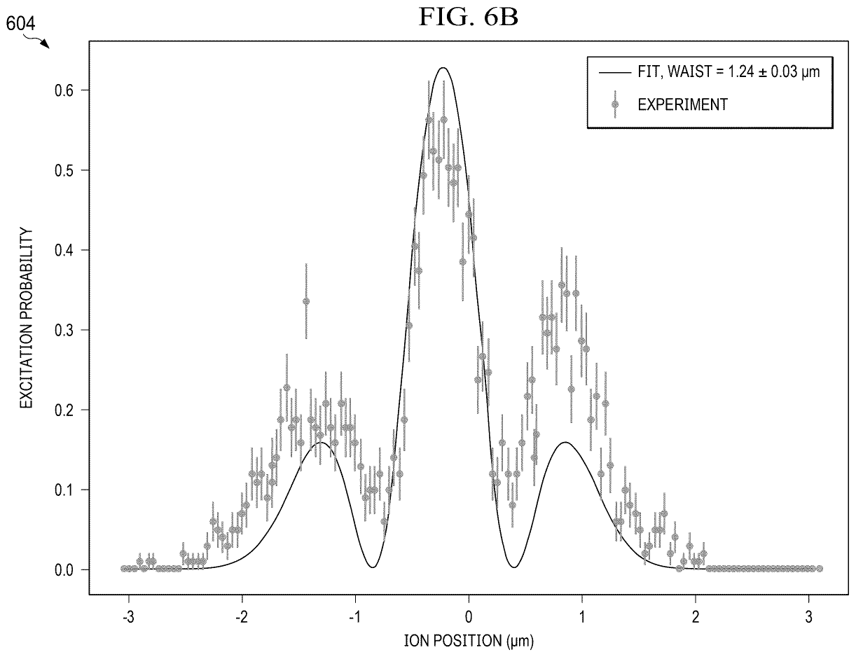

FIGS. 6A-8 illustrate graph diagrams relating to data obtained from a practical applications of the techniques described herein. FIG. 6A provides a graph 602 showing the excitation probability of the carrier transition as a function of ion position with a probe time of 2 μs. The fitted profile is for a Hermite-Gaussian profile with a sinusoid envelope, with a waist of approximately 1.23 2 μm. In this scenario, the system 100 shuttled the ion through the beam while driving the carrier transition for 2 μs to profile the exact shape of the coupling fields. Illustratively, the center of the profile shows a clear dip where the transition strength nears zero but the spatial gradient of the profile is maximized. Such results indicate that the carrier transition is structurally suppressed at the beam center and such suppression is not a result of detuning.

FIG. 6B provides a graph 604 showing the combined profile of the lasers interacting with the ions to perform the Raman blue sideband transition with a probe time of 20 μs. The fitted profile is for the derivative of a Hermite-Gaussian profile with a sinusoid envelope. The center of the profile shows a clear peak where the motional-interaction strength maximizes along with the gradient of the carrier profile in FIG. 6A, which corresponds to a maximum spin-motion coupling strength.

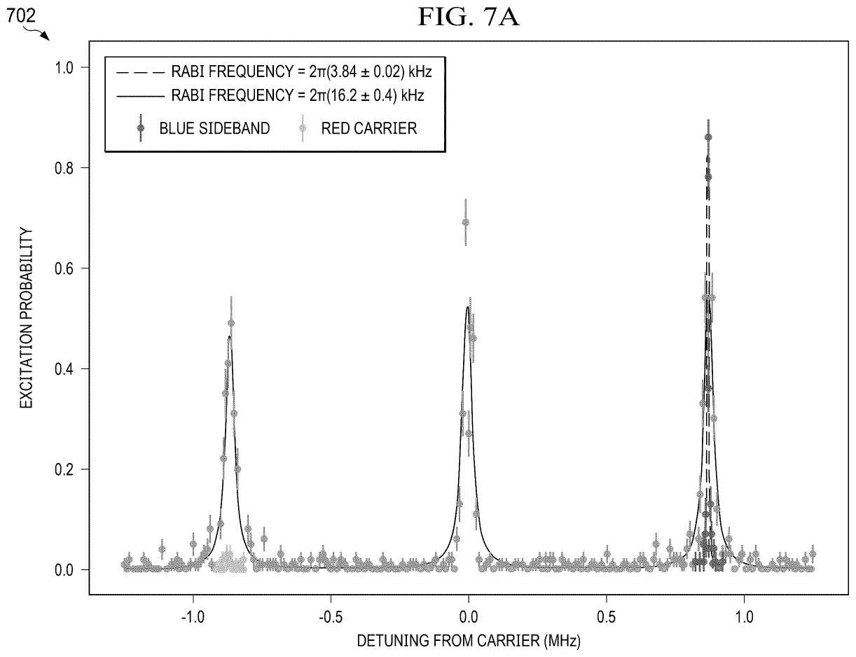

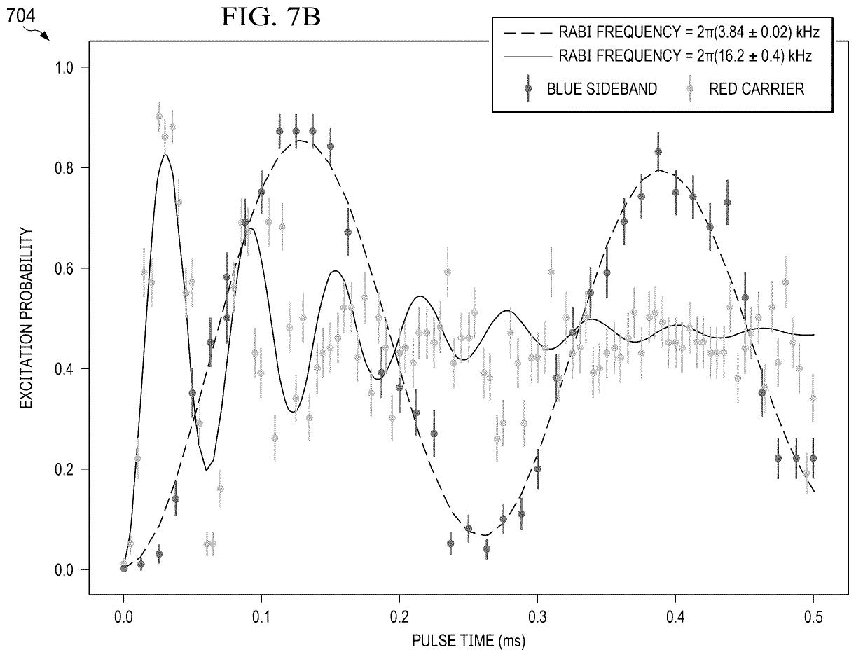

FIG. 7A provides a graph 702 showing the full spectrum surrounding the carrier transition when the ion is placed at the center of the profile of FIG. 6A. The center curve shows the spectrum after Doppler cooling when driven for 20 μs, where the motional transitions are strengthened by having a finite temperature. Motional sidebands appear relatively strong because the ion has finite thermal occupation. Further, as shown, both red and blue sidebands are visible. The left and right curves show the spectrum when the ion is ground state-cooled using sideband cooling on the red sideband, driven for 140 μs. The left and right curves indicate that the red sideband is almost fully suppressed, while the blue sideband is almost completely coherent. The carrier strength remains about constant when ground state-cooled. The graph 702 demonstrates that at the spatial null, the carrier transition is suppressed by the field structure and that sideband transitions remain accessible. Further, the structured beam enables clean spectral separation of motional transitions. FIG. 7B is a graph 704 depicting Rabi oscillations when driving the carrier transition and blue sideband transition after ground state cooling on the red sideband. The carrier transition is about four times faster than the ground state cooled sideband, and the blue sideband oscillates coherently for about 500 μs.

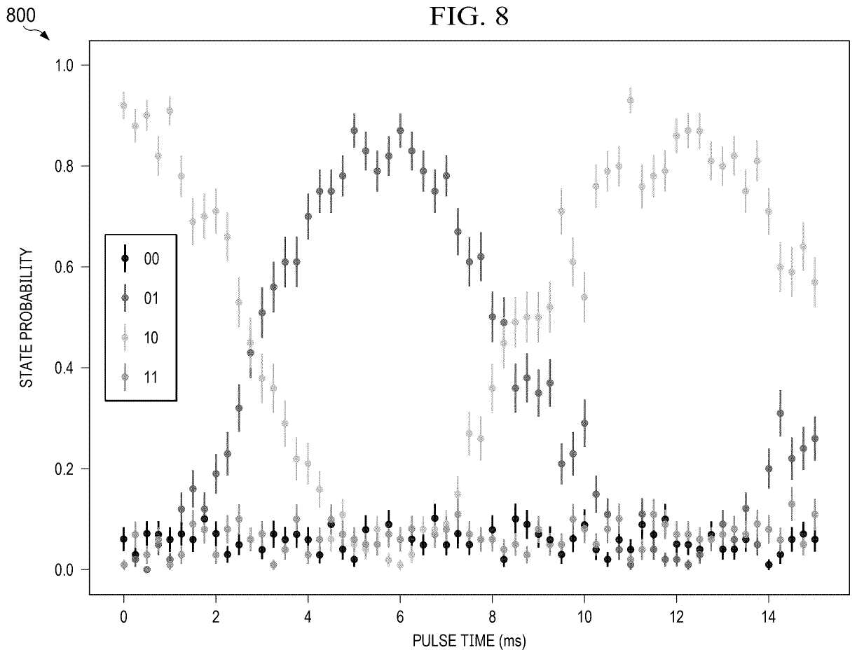

FIG. 8 is a graph 800 depicting oscillations of the odd-parity states while driving an iSWAP (imaginary swap) gate using a Hermite-Gaussian profile Raman transition. Although the strength of the interaction was small due to limited laser power being split twice over to allow for perfect co-propagation and that the population of even parity states was large (possibly caused by imperfect preparation of only one of the ions into the excited state), the graph 800 demonstrates the feasibility of using the spatial profiles disclosed herein to perform spin-spin entanglement. More particularly, the oscillations between odd-parity states indicate that the structured Raman beam successfully mediates a spin-spin interaction through the shared motional mode and that the carrier suppression and preserved gradient coupling techniques can be extended beyond single-ion sideband control to two-qubit entanglement.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

1. A method, comprising:
generating, by a quantum computing system confining a plurality of quantum particles in respective trapping potentials defining at least one shared bosonic mode, a first electromagnetic field having a first spatial field profile;
generating, by the quantum computing system, a second electromagnetic field having a second spatial field profile, the second spatial field profile comprising an electric-field null region and a non-zero transverse spatial gradient in a vicinity of the null region;
combining, by the quantum computing system, the first electromagnetic field and the second electromagnetic field to form a driven interaction field having a frequency component corresponding to an internal state transition of the quantum particles;
directing, by the quantum computing system, the driven interaction field toward the plurality of quantum particles such that at least one quantum particle is positioned substantially at the null region of the second spatial field; and
applying, by the quantum computing system, the driven interaction field to induce a transition that couples an internal state of the at least one quantum particle to the shared bosonic mode while structurally suppressing a carrier transition of the internal state, thereby mediating entanglement between the plurality of quantum particles.

2. The method of claim 1, wherein the plurality of quantum particles comprise trapped ions confined in an ion trap.

3. The method of claim 1, wherein the shared bosonic mode comprises a collective motional mode of the plurality of quantum particles.

4. The method of claim 1, wherein the second spatial field profile comprises a first-order Hermite-Gaussian mode.

5. The method of claim 1, wherein the second spatial field profile comprises a higher-order Hermite-Gaussian mode.

6. The method of claim 1, wherein the second spatial field profile comprises a Laguerre-Gaussian mode.

7. The method of claim 1, wherein the second spatial field profile is generated using a phase-conversion optical element.

8. The method of claim 1, wherein the first and second electromagnetic fields are co-propagating.

9. The method of claim 1, wherein the first and second electromagnetic fields are derived from a common laser source and are frequency shifted prior to combination.

10. The method of claim 1, further comprising dynamically compensating residual carrier coupling using phase control.

11. A quantum computing system comprising:
a quantum processing unit;
one or more processors; and
a memory storing a plurality of instructions, which, when executed on the one or more processors, causes the quantum computing system to:
confine a plurality of quantum particles in respective trapping potentials defining at least one shared bosonic mode;
generate a first electromagnetic field having a first spatial field profile;
generate a second electromagnetic field having a second spatial field profile, the second spatial field profile comprising an electric-field null region and a non-zero transverse spatial gradient in a vicinity of the null region;
combine the first electromagnetic field and the second electromagnetic field to form a driven interaction field having a frequency component corresponding to an internal state transition of the quantum particles;
direct the driven interaction field toward the plurality of quantum particles such that at least one quantum particle is positioned substantially at the null region of the second spatial field; and
apply the driven interaction field to induce a transition that couples an internal state of the at least one quantum particle to the shared bosonic mode while structurally suppressing a carrier transition of the internal state, thereby mediating entanglement between the plurality of quantum particles.

12. The quantum computing system of claim 11, wherein the plurality of quantum particles comprise trapped ions confined in an ion trap.

13. The quantum computing system of claim 11, wherein the shared bosonic mode comprises a collective motional mode of the plurality of quantum particles.

14. The quantum computing system of claim 11, wherein the second spatial field profile comprises a first-order Hermite-Gaussian mode.

15. The quantum computing system of claim 11, wherein the second spatial field profile comprises a higher-order Hermite-Gaussian mode.

16. The quantum computing system of claim 11, wherein the second spatial field profile comprises a Laguerre-Gaussian mode.

17. The quantum computing system of claim 11, further comprising a phase-conversion optical element configured to generate the second spatial field profile.

18. The quantum computing system of claim 11, wherein the first electromagnetic field and the second electromagnetic field are co-propagating.

19. The quantum computing system of claim 11, wherein the first electromagnetic field and the second electromagnetic field are derived from a common laser source and are frequency shifted prior to combination.

20. The quantum computing system of claim 11, wherein the plurality of instructions further causes the quantum computing system to dynamically compensate residual carrier coupling using phase control.
